(19) United States
(12) Patent Application Publication
(10) Pub. No.: US 2026/0337464 A1
(43) Pub. Date: Oct. 29, 2026

(54) WATER-BASED ADHESIVE

(71) Applicant: University of Newcastle upon Tyne, Tyne and Wear (GB)

(72) Inventors: Katarina NOVAKOVIC, Tyne and Wear (GB); Adriana Sierra ROMERO, Tyne and Wear (GB); Mark GEOGHEGAN, Tyne and Wear (GB)

(73) Assignee: University of Newcastle upon Tyne, Tyne and Wear (GB)

(21) Appl. No.: 19/122,401

(22) PCT Filed: Oct. 18, 2023
(86) PCT No.: PCT/GB2023/052706

§ 371 Date: Apr. 18, 2025

(30) Foreign Application Priority Data
Oct. 19, 2022 (GB) 2215426.4
May 19, 2023 (GB) 2307547.6

(51) Int. Cl. C09J 133/08; C09J 11/06; C09J 11/08

(52) U.S. Cl. CPC C09J 133/08; C09J 11/06; C09J 11/08

(57) ABSTRACT

The disclosure relates to an adhesive kit comprising first and second emulsions configured to reversibly adhere to one another. The invention also provides methods of using said kit. The invention also provides aqueous emulsions comprising particles dispersed in an aqueous phase, the particles comprising a hydrophobic polymer and being positively or negatively charged.

This invention relates to an adhesive kit comprising first and second emulsions configured to reversibly adhere to one another. The invention also provides methods of using said kit. The invention also provides aqueous emulsions comprising particles dispersed in an aqueous phase, the particles comprising a hydrophobic polymer and being positively or negatively charged.

### BACKGROUND

Organic solvent-free adhesives are more eco-friendly than volatile organic compound (VOC) based solvents and are of particular interest in textile, industrial, foam, and fabric laminations. The increased use of solvent free adhesives is also being driven by a need for increased sustainability and the need to lower VOCs due to regulatory and customer pressure. This has led to several new generations of adhesives and sealants. Examples of these are fast-curing epoxy and polyurethane reactive (PUR), UV and light-cured acrylics, and cyanoacrylate adhesives.

The demand for water-based adhesives has increased in the last two decades primarily from the packaging and converting industries. The type of packaging adhesive used depends on such factors as the material to be bonded, the production equipment and the end-use demands on the bond. Such adhesives typically contain a polymer responsible for the cohesion (i.e., internal strength) of the adhesive. The required penetration is achieved by dissolving or dispersing the polymer in water, or by melting it into a liquid form. The adhesive is returned to a solid condition by removing the water by absorption or evaporation, or by cooling the melt.

While adhesives themselves do not normally represent a major environmental problem, the global efforts to address environmental issues focus largely on recycling used materials. Often, these used materials include components held in place by adhesives (e.g., labels). Such labels are often difficult to remove from the bottles, complicating the recycling process.

Accordingly, there is a need in the art for a water-based adhesive that is reversible on a large scale. There is also a need to develop an adhesive that is environmentally sustainable.

### BRIEF SUMMARY OF THE DISCLOSURE

In accordance with a first aspect of the present invention, there is provided an adhesive kit comprising a first aqueous emulsion comprising particles dispersed in a first aqueous phase, wherein the particles of the first aqueous emulsion comprise a first hydrophobic polymer and wherein the particles of the first aqueous emulsion are positively charged, and a second aqueous emulsion comprising particles dispersed in a second aqueous phase, wherein the particles of the second aqueous emulsion comprise a second hydrophobic polymer and wherein the particles of the second aqueous emulsion are negatively charged. Typically, the first and second aqueous emulsions are configured to reversibly adhere to one another.

The adhesive kit of the invention achieves several advantages over prior art adhesives.

The adhesive kit employs two water-based emulsions which may be coated onto opposing surfaces in order to reversibly adhere the surfaces to one another. In particular, the inventors have found that a first surface coated with a first aqueous emulsion comprising a hydrophobic polymer and a positively charged polymer can adhere to one coated with a second aqueous emulsion comprising a hydrophobic polymer and a negatively charged polymer to form a bonded interface. Without wishing to be bound by theory, it is thought that the electrostatic attraction between the positively and negatively charged polymers facilitates the adhesion. The two components adhere to one another in water and remain adhered even after the adhesive has dried. Typically, moisture does not compromise the adhesion between the two components.

Additionally, the adhesion can be reversed by altering the local pH at the bonded interface. Without wishing to be bound by theory, it is thought that altering the local pH causes either the positively charged polymer of the first aqueous emulsion or the negatively charged polymer of the second aqueous emulsion to become neutral. For example, when the pH is reduced, the negatively charged polymer will be protonated while the charge of the positively charged polymer will be unchanged. Conversely, when the pH is increased, the positively charged polymer may be deprotonated while the charge of the negatively charged polymer remains unchanged. As a result, in both circumstances where the pH is altered, the electrostatic interaction between the particles of the first aqueous emulsion and the particles of the second aqueous emulsion will fail, and thus the adhesion of the first and second surfaces to one another would be reversed. Accordingly, the adhesive kit of the present invention provides facile and effective reversibility without the need for extensive chemistry to be performed. This is particularly advantageous in large scale recycling processes.

Additionally, the adhesive kit of the invention is solvent-free and uses commodity materials, thereby providing a system that is inexpensive, scalable, and environmentally friendly.

In a second aspect of the present invention, there is provided a method of using the adhesive kit of the first aspect to adhere two surfaces together, comprising: coating a first surface with the first aqueous emulsion; coating a second surface with the second aqueous emulsion; and contacting the first surface coated with the first aqueous emulsion with the second surface coated with the second aqueous emulsion to adhere the first and second surfaces to one another at a bonded interface.

In a third aspect of the invention, there is provided a system obtained or obtainable by the method of the second aspect, the system comprising the first surface and the second surface, wherein the first surface is adhered to the second surface.

In a fourth aspect of the invention, there is provided a method of producing the adhesive kit of the first aspect, the method comprising forming the first aqueous emulsion and second aqueous emulsion.

In a fifth aspect of the present invention, there is provided an aqueous emulsion (hereafter this may be referred to as a first aqueous emulsion) comprising particles dispersed in an aqueous phase (hereafter this may be referred to as a first aqueous phase), wherein the particles of the aqueous emulsion comprise a hydrophobic polymer (hereafter this may be referred to as a first hydrophobic polymer) and wherein the particles of the aqueous emulsion are positively charged.

In a sixth aspect of the present invention, there is provided an aqueous emulsion (hereafter this may be referred to as a second aqueous emulsion) comprising particles dispersed in an aqueous phase (hereafter this may be referred to as a second aqueous phase), wherein the particles of the aqueous emulsion comprise a hydrophobic polymer (hereafter this may be referred to as a second hydrophobic polymer) and wherein the particles of the aqueous emulsion are negatively charged.

In a seventh aspect of the present invention, there is provided a method of using an emulsion of the fifth or sixth aspects to adhere two surfaces to one another, comprising: coating a first surface and/or a second surface with the aqueous emulsion of the fifth or sixth aspect; and contacting the first surface with the second surface to adhere the first and second surfaces to one another at a bonded interface.

The adhesives formed in the methods of the invention or from the products of the invention are flexible when bonded, unlike some prior art adhesives which can impart rigidity to any flexible substrates that they are used to adhere. Further, the adhesives are transparent and remain transparent when bonded, giving an adhered end-product that is more aesthetically pleasing than some known adhesive systems.

### Adhesive Kit and Aqueous Emulsions

The first hydrophobic polymer may be a polystyrene, a polyacrylate, a polymethacrylate, a polyvinyl, a polydiene, or a mixture/copolymer thereof. The first hydrophobic polymer may be selected from: polystyrene, poly(butyl acrylate), poly(styrene-butyl acrylate) copolymer or polybutadiene. The first hydrophobic polymer may be a polystyrene, a polyacrylate, a polymethacrylate, or a polyvinyl, or a mixture/copolymer thereof. The first hydrophobic polymer may be selected from: polystyrene, poly(butyl acrylate), or poly(styrene-butyl acrylate) copolymer. The first hydrophobic polymer may be a poly(styrene-butyl acrylate) copolymer.

Where the first hydrophobic polymer is a poly(styrene-butyl acrylate) copolymer, the copolymer may comprise styrene and butyl acrylate in a weight ratio in the range of from 3:1 to 0.01:1, e.g. a weight ratio in the range of from 1.5:1 to 1:1.5. It may be that the copolymer comprises styrene and butyl acrylate in a weight ratio of about 1:1.5.

The particles of the first aqueous emulsion may further comprise a positively charged polymer (e.g. a polycation). The positively charged polymer (e.g. the polycation) may be associated with the first hydrophobic polymer. For example, the positively charged polymer (e.g. the polycation) may be associated with the first hydrophobic polymer via hydrophobic, electrostatic, or covalent interactions.

It may be that the components of the particle are arranged and selected such that the positively charged groups (e.g. amino groups) are situated at the surface of the particle. It may be that the components of the particle are arranged and selected such that there is a higher concentration of the positively charged groups (e.g. amino groups) at the surface of the particle than there is in the inner portions of the particle. Thus the hydrophobic polymer may be situated in the inner portions of the particle with the positively charged polymer situated on the outer portions of the particle.

The positively charged polymer may be a polymeric species comprising one or more positively charged groups. The positively charged polymer may be a polymeric species comprising a plurality of positively charged groups.

In certain embodiments, the first aqueous emulsion has a pH of from about 5 to about 8. Preferably, the first aqueous emulsion has a pH of about 5. The positively charged polymer (e.g. the polycation) may comprise one or more basic groups that are protonated at the pH of the first aqueous emulsion, e.g. in the pH range from about 5 to about 8, to form a cation. The positively charged polymer (e.g. the polycation) may comprise a plurality of basic groups that are protonated at the pH of the first aqueous emulsion, e.g. in the pH range from about 5 to about 8, to form a cation. The positively charged polymer (e.g. the polycation) may comprise one or more amino groups. The positively charged polymer (e.g. the polycation) may comprise a plurality of amino groups. The amino groups may be primary, secondary or tertiary amino groups. The amino groups may be primary amino groups.

The positively charged polymer may be selected from the group comprising: chitosan, poly amino acrylates, poly amino methacrylates, poly allylamines and poly ethyleneimines. The positively charged polymer may be selected from chitosan, poly[2-(dimethylamino)ethyl acrylate], poly[2-(dimethylamino)ethyl methacrylate], and polyethylenimine. The positively charged polymer may be chitosan.

The particles of the first aqueous emulsion may be present in an amount in the range from about 20% to about 40% by weight of the first aqueous emulsion. The particles of the first aqueous emulsion may be present in an amount of about 30% by weight of the first aqueous emulsion.

The particles of the first aqueous emulsion may comprise the hydrophobic polymer and the positively charged polymer (e.g. the polycation) in a ratio in the range from about 20:1 to about 60:1 by weight of the first aqueous emulsion.

The first aqueous emulsion may have a low shear viscosity in the range from about 25 to about 100 Pa s. The first aqueous emulsion may have a high shear viscosity in the range from about 50 to about 150 mPa s.

The second hydrophobic polymer may be a polystyrene, a polyacrylate, a polymethacrylate, a polyvinyl, a polydiene, or a mixture/copolymer thereof. The second hydrophobic polymer may be selected from: polystyrene, poly(butyl acrylate), poly(styrene-butyl acrylate) copolymer or polybutadiene. The second hydrophobic polymer may be a polystyrene, a polyacrylate, a polymethacrylate, or a polyvinyl, or a mixture/copolymer thereof. The second hydrophobic polymer may be selected from: polystyrene, poly(butyl acrylate), or poly(styrene-butyl acrylate) copolymer. The second hydrophobic polymer may be a poly(styrene-butyl acrylate) copolymer.

Where the second hydrophobic polymer is a poly(styrene-butyl acrylate) copolymer, the copolymer may comprise styrene and butyl acrylate in a weight ratio in the range of from 3:1 to 0.01:1, e.g. a weight ratio in the range of from 1.5:1 to 1:1.5. It may be that the copolymer comprises styrene and butyl acrylate in a weight ratio of about 1:1.5.

It may be that the first hydrophobic polymer and the second hydrophobic polymer are the same species. For example, both the first hydrophobic polymer and the second hydrophobic polymer may be a poly(styrene-butyl acrylate) copolymer.

The particles of the second aqueous emulsion may further comprise a negatively charged polymer (e.g. a polyanion). The negatively charged polymer (e.g. the polyanion) may be associated with the second hydrophobic polymer. For example, the negatively charged polymer (e.g. the polyanion) may be associated with the second hydrophobic polymer via hydrophobic, electrostatic or covalent interactions.

The negatively charged polymer may be a polymeric species having one or more negatively charged groups. The negatively charged polymer may be a polymeric species having a plurality of negatively charged groups.

It may be that the components of the particle are arranged and selected such that the negatively charged groups (e.g. carboxylate groups) are situated at the surface of the particle. It may be that the components of the particle are arranged and selected such that there is a higher concentration of the negatively charged groups (e.g. carboxylate groups) at the surface of the particle than there is in the inner portions of the particle. Thus the hydrophobic polymer may be situated in the inner portions of the particle with the negatively charged polymer situated on the outer portions of the particle.

In certain embodiments, the second aqueous emulsion has a pH of from about 5 to about 8, optionally about 5. The negatively charged polymer (e.g. the polyanion) may comprise one or more groups that are deprotonated at the pH of the second aqueous emulsion, e.g. in the pH range from about 5 to about 8, to form an anion. The negatively charged polymer (e.g. the polyanion) may comprise a plurality of groups that are deprotonated at the pH of the second aqueous emulsion, e.g. in the pH range from about 5 to about 8, to form an anion. The negatively charged polymer (e.g. the polyanion) may comprise carboxylate, sulfonate, phosphonate, or boronate groups. The negatively charged polymer (e.g. the polyanion) may comprise one or more carboxylate groups. The negatively charged polymer (e.g. the polyanion) may comprise a plurality of carboxylate groups.

The negatively charged polymer (e.g. the polyanion) may be selected from the group comprising: poly acrylic acids, acidic biopolymers, poly sulfonic acids and poly maleic acids. The negatively charged polymer (e.g. the polyanion) may be selected from poly(acrylic acid), alginate, carboxymethyl cellulose, xanthan gum, gum Arabic, carrageenan, poly(2-acrylamido-2-methylpropanesulfonic acid), poly(methacrylic acid), poly(maleic acid) and poly(vinyl sulfonic acid). The negatively charged polymer (e.g. the polyanion) is poly(acrylic acid).

The particles of the second aqueous emulsion may be present in an amount in the range from about 20% to about 40% by weight of the second aqueous emulsion. The particles of the second aqueous emulsion may be present in an amount of about 30% by weight of the second aqueous emulsion.

The particles of the second aqueous emulsion may comprise the hydrophobic polymer and the negatively charged polymer (e.g. the polyanion) in ratio in the range from about 20:1 to about 60:1 by weight of the second aqueous emulsion.

The second aqueous emulsion may have a low shear viscosity in the range from about 25 to about 100 Pa s. The first aqueous emulsion may have a high shear viscosity in the range from about 50 to about 150 mPa s.

The low shear viscosity of the first aqueous emulsion may be about equal to the low shear viscosity of the second aqueous emulsion.

The high shear viscosity of the first aqueous emulsion may be about equal to the high shear viscosity of the second aqueous emulsion.

The first hydrophobic polymer may have a glass transition temperature (T_{g}) of less than about 50 °C, less than about 25 °C, or less than about 20 °C. The first hydrophobic polymer may have a glass transition temperature (T_{g}) of greater than about −5 0 °C. The first hydrophobic polymer may have a glass transition temperature (T_{g}) of from about −50 °C to about 50 °C, from about −50 °C to about 25 °C, from about −50 °C to about 20 °C, from about −25 °C to about 20 °C, from about 0 °C to about 20 °C, or from about 10 °C to about 20 °C.

The second hydrophobic polymer may have a glass transition temperature (T_{g}) of less than about 50 °C, less than about 25 °C, or less than about 20 °C. The second hydrophobic polymer may have a glass transition temperature (T_{g}) of greater than about −50 °C. The second hydrophobic polymer may have a glass transition temperature (T_{g}) of from about −50 °C to about 50 °C, from about −50 °C to about 25 °C, from about −50 °C to about 20 °C, from about −25 °C to about 20 °C, from about 0 °C to about 20 °C, or from about 10 °C to about 20 °C.

The particles of the second aqueous emulsion may further comprise one or more additives. The one or more additives may each comprise one or more sulfate groups. In embodiments, the particles of the second aqueous emulsion each comprise one additive. In embodiments, the particles of the second aqueous emulsion each comprise an additive comprising one or more sulfate groups.

Each additive may be an anionic surfactant or a cationic surfactant.

Each additive may be an anionic surfactant. For example, the additive may be an anionic surfactant selected from: an alkyl sulfate, an alkyl ether sulfate, and an alkyl sulfonate. Preferably, the additive is sodium dodecyl sulfate.

Each additive may be a cationic surfactant. For example, the additive may be a cationic surfactant selected from: an alkyl ammonium halide or other alkyl ammonium salt. Specific examples of cationic surfactants include triethylamine hydrochloride, octenidine dihydrochloride, adogen, cetrimonium bromide, cetyl pyridinium chloride, benzethonium chloride and dimethyldioctadecylammonium chloride.

Preferably, the difference in pH between the first and second aqueous emulsions is 2 or less. The difference in pH between the first and second aqueous emulsions may be 1 or less. The difference in pH between the first and second aqueous emulsions is 0.5 or less. It may be that both the first and second aqueous emulsions have a pH in the range from about 5 to about 8, optionally about 5.

The particles of the first aqueous emulsion may have a size of in the range about 0.1 to about 200 μm, optionally in the range of from about 80 to about 200 μm. The particles of the first aqueous emulsion may have a size of in the range about 10 nm to about 20 μm, optionally in the range of from about 20 nm to about 10 μm.

The particles of the second aqueous emulsion may have a size in the range from about 0.1 to about 200 μm, optionally in the range of from about 80 to about 200 μm. The particles of the second aqueous emulsion may have a size of in the range about 10 nm to about 20 μm, optionally in the range of from about 20 nm to about 10 μm.

It may be that the particles of the first aqueous emulsion and the particles of the second aqueous emulsion have a size in the range from about 0.1 to about 200 μm, optionally in the range of from about 80 to about 200 μm. It may be that the particles of the first aqueous emulsion and the particles of the second aqueous emulsion have a size in the range about 10 nm to about 20 μm, optionally in the range of from about 20 nm to about 10 μm.

The size of the particles may be determined by dynamic light scattering. This process involves measuring the Brownian motion of particles by illuminating the particles with a laser and analysing the intensity fluctuations in the scattered light to determine particle size. An instrument for measuring dynamic light scattering (e.g. a Zetasizer system) determines the average particle sizes and the polydispersity index from a sample, and typically produces these in a size distribution curve or histogram. To determine the particle size in the first or second aqueous emulsion, a sample of the first or second emulsion may be diluted with deionised water and placed in a dynamic light scattering instrument.

The first aqueous emulsion and the second aqueous emulsion are configured to reversibly adhere to one another. It may be that the particles of the first aqueous emulsion and the particles of the second aqueous emulsion interact with one another via ionic interactions between the positively charged polymer of the particles of the first aqueous emulsion and the negatively charged polymer of the particles of the second aqueous emulsion.

### Method of Using the Adhesive Kit

In a second aspect, there is provided a method of using the adhesive kit of the first aspect, the method comprising coating a first surface with the first aqueous emulsion; coating a second surface with the second aqueous emulsion; and contacting the first surface coated with the first aqueous emulsion with the second surface coated with the second aqueous emulsion to adhere the first and second surfaces to one another at a bonded interface.

The method may further comprise detaching the first and second surfaces from one another by altering the pH of the first and second surfaces at the bonded interface. For example, the method may comprise reducing the pH of the first and second surfaces at the bonded interface to detach the first and second surfaces from one another. Alternatively, the method may comprise increasing the pH of the first and second surfaces at the bonded interface to detach the first and second surfaces from one another.

The step of detaching the first and second surfaces from one another at the bonded interface may comprise treating the first and second surfaces with an acidic solution having a pH of less than about 5, less than about 4, less than about 3, less than about 2 or less than about 1 at the bonded interface. Alternatively, the step of detaching the first and second surfaces from one another at the bonded interface may comprise treating the first and second surfaces with an alkaline solution having a pH of greater than about 9, greater than about 10, greater than about 11, greater than about 12 or greater than about 13 at the bonded interface. Detaching may be achieved by submerging or immersing the product containing the adhesive in the acidic or alkaline solution.

The step of coating the first and second surface may comprise applying the first aqueous emulsion and second aqueous emulsion to the first and second surfaces respectively in a weight/area ratio in the range of from about 1 mg/cm² to about 100 mg/cm². The step of coating the first and second surface may comprise applying the first aqueous emulsion and second aqueous emulsion to the first and second surfaces respectively in a weight/area ratio in the range of from about 10 mg/cm² to about 100 mg/cm². It may be that the step of coating the first and second surface may comprise applying the first aqueous emulsion and second aqueous emulsion to the first and second surfaces respectively in a weight/area ratio in the range of from about 20 mg/cm² to about 30 mg/cm².

The first and second surfaces may be independently selected from: polypropylene (PP), poly(ethylene terephthalate) (PET), high density polyethylene (HDPE), low density polyethylene (LDPE), polyvinylchloride (PVC), polystyrene (PS), melamine, cellulose acetate, unspecified polymeric resin, metal (e.g. steel, copper), ceramics, silicon, wood, glass, and printed circuit board. The first and second surfaces may be independently selected from: polypropylene, poly(ethylene terephthalate), HDPE, LDPE, PVC, PS, melamine, cellulose acetate, unspecified polymeric resin, metal, ceramics, silicon and glass. The first and second surfaces may be independently selected from: polypropylene (PP), poly(ethylene terephthalate) (PET), high density polyethylene (HDPE), low density polyethylene (LDPE), cellulose acetate, steel, copper, wood, glass, and printed circuit board. The first and second surfaces may be independently selected from: polypropylene, poly(ethylene terephthalate), HDPE, LDPE, PVC, PS, melamine, unspecified polymeric resin, and glass. The first and second surfaces may be independently selected from: polypropylene (PP) and poly(ethylene terephthalate) (PET).

It may be that at least one of the first and second surfaces forms part of a flexible substrate. It may be that the first surface forms part of a flexible substrate. It may be that the second surface forms part of a flexible substrate. It may be that the first and the second surfaces each form part of a flexible substrate.

The steps of coating the surfaces may be achieved using a brush or applicator. The steps of coating the surfaces may comprise spray coating.

The method may be a method of labelling bottles, wherein either the first surface or the second surface is the exterior surface of a bottle and the other of the first surface or the second surface is the label.

Following the step of detaching the first and second surfaces from one another, the method may further comprise cleaning the first surface and/or second surface to remove excess adhesive. Thus, after using the adhesive kit of the disclosure, the components having the first surface and/or second surface may be recycled.

The step of cleaning the first surface and/or second surface may comprise treating the first surface and/or second surface with an organic solvent.

The organic solvent may be selected from acetone and turpentine.

### Method of Producing Adhesive Kit

In a third aspect, there is provided a method of producing the adhesive kit of the first aspect, the method comprising forming the first aqueous emulsion and second aqueous emulsion.

The method may comprise stirring one or more first hydrophobic monomers with a positively charged polymer to form an emulsion; and polymerising the emulsion in water to form the first aqueous emulsion.

The step of forming the emulsion from the one or more first hydrophobic monomers and the positively charged polymer may be performed for at least 5 minutes, optionally for at least 10 minutes.

The step of polymerising the emulsion to form the first aqueous emulsion may involve a free-radical emulsion polymerisation. Thus, this step may include the addition of a free radical initiator. The free radical initiator may be a persulfate, a peroxide, or an aliphatic azo compound. For example, the free radical initiator may be selected from: potassium persulfate (KPS) and azobisisobutyronitrile (AIBN).

The step of polymerising the emulsion to form the first aqueous emulsion may be performed at a temperature of at least 70 °C.

The step of polymerising the emulsion to form the first aqueous emulsion may be performed for at least 4 hours.

The one or more first hydrophobic monomers may be selected from: styrenes (e.g. butyl styrene), acrylates (e.g. butyl acrylate), methacrylates (e.g. butyl methacrylate, ethylhexyl methacrylate), ethylhexyl methacrylate), vinyls (e.g. vinyl acetate, vinyl laurate), acrylated soybean oil, divinylbenzene. The one or more hydrophobic monomers may be selected from: styrene and butyl acrylate.

The method may comprise stirring one or more second hydrophobic monomers with an additive to form an emulsion; polymerising the emulsion in water to form an intermediate aqueous emulsion; adding a negatively charged monomer to the intermediate aqueous emulsion; and polymerising the mixture of intermediate aqueous emulsion and negatively charged monomer in water to form a second aqueous emulsion.

The step of stirring the one or more second hydrophobic monomers with the additive to form an emulsion may be performed for at least 5 minutes.

The step of polymerising the emulsion to form the intermediate aqueous emulsion may involve a free-radical emulsion polymerisation. Thus, this step may include the addition of a free radical initiator. The free radical initiator may be a persulfate, a peroxide, or an aliphatic azo compound. For example, the free radical initiator may be selected from: potassium persulfate (KPS), azobisisobutyronitrile (AIBN).

The step of polymerising the emulsion to form the intermediate aqueous emulsion may be performed at a temperature of at leas t 70 °C.

The step of polymerising the emulsion to form the intermediate aqueous emulsion may be performed for at least 2 hours.

The step of adding the negatively charged monomer to the intermediate aqueous emulsion may further comprise adding more of the free radical initiator.

The step of polymerising the mixture of intermediate aqueous emulsion and negatively charged monomer in water to form the second aqueous emulsion may be performed at a temperature of at lea st 70 °C.

The step of polymerising the mixture of intermediate aqueous emulsion and negatively charged monomer in water to form the second aqueous emulsion may be performed for at least 2 hours.

The one or more second hydrophobic monomers may be selected from: styrenes (e.g. butyl styrene), acrylates (e.g. butyl acrylate), methacrylates (e.g. butyl methacrylate, ethylhexyl methacrylate), ethylhexyl methacrylate), vinyls (e.g. vinyl acetate, vinyl laurate), acrylated soybean oil, divinylbenzene. The one or more hydrophobic monomers may be selected from: styrene and butyl acrylate.

The positively charged polymer, negatively charged polymer and additive may be as described in any of the embodiments in this specification relating to the first aspect of the invention.

### Method of Adhering Two Surfaces

The seventh aspect of the invention provides a method of adhering two surfaces to one another, the method comprising: coating a first surface and/or a second surface with an aqueous emulsion; and contacting the first surface with the second surface to adhere the first and second surfaces to one another at a bonded interface; wherein the aqueous emulsion is selected from:
an aqueous emulsion comprising particles dispersed in an aqueous phase, wherein the particles of the aqueous emulsion comprise a hydrophobic polymer and wherein the particles of the aqueous emulsion are positively charged;
an aqueous emulsion comprising particles dispersed in an aqueous phase, wherein the particles of the aqueous emulsion comprise a hydrophobic polymer and wherein the particles of the aqueous emulsion are negatively charged.

The inventors have surprisingly found that the individual emulsions of the invention are strong non-reversible adhesives. In particular, these adhesives have been shown to be effective adhesives for polypropylene.

The method may comprise coating only the first surface with the aqueous emulsion. The method may comprise coating only the second surface with the aqueous emulsion. The method may comprise coating both the first surface and the second surface with the aqueous emulsion.

The steps of coating the surface or surfaces may be achieved using a brush or applicator. The steps of coating the surface or surfaces may comprise spray coating.

The step of coating the first and/or second surface may comprise applying the aqueous emulsion to the first and/or second surfaces in a weight/area ratio in the range of from about 1 mg/cm² to about 100 mg/cm². It may be that the step of coating the first and/or second surface comprises applying the aqueous emulsion to the first and/or second surfaces in a weight/area ratio in the range of from about 20 mg/cm² to about 30 mg/cm².

The first and second surfaces may be independently selected from: polypropylene (PP), poly(ethylene terephthalate) (PET), high density polyethylene (HDPE), low density polyethylene (LDPE), polyvinylchloride (PVC), polystyrene (PS), melamine, cellulose acetate, unspecified polymeric resin, metal (e.g. steel, copper), ceramics, silicon, wood, glass, and printed circuit board. The first and second surfaces may be independently selected from: polypropylene, poly(ethylene terephthalate), HDPE, LDPE, PVC, PS, melamine, cellulose acetate, unspecified polymeric resin, metal, ceramics, silicon and glass. The first and second surfaces may be independently selected from: polypropylene (PP), poly(ethylene terephthalate) (PET), high density polyethylene (HDPE), low density polyethylene (LDPE), cellulose acetate, steel, copper, wood, glass, and printed circuit board. The first and second surfaces may be independently selected from: polypropylene, HDPE and LDPE. The first and second surfaces may be polypropylene. The first and second surfaces may be independently selected from: HDPE and LDPE.

The first surface may be selected from: polypropylene (PP), poly(ethylene terephthalate) (PET), high density polyethylene (HDPE), low density polyethylene (LDPE), polyvinylchloride (PVC), polystyrene (PS), melamine, cellulose acetate, unspecified polymeric resin, metal (e.g. steel, copper), ceramics, silicon, wood, glass, and printed circuit board. The first surface may be selected from: polypropylene, poly(ethylene terephthalate), HDPE, LDPE, PVC, PS, melamine, cellulose acetate, unspecified polymeric resin, metal, ceramics, silicon and glass. The first surface may be independently selected from: polypropylene (PP), poly(ethylene terephthalate) (PET), high density polyethylene (HDPE), low density polyethylene (LDPE), cellulose acetate, steel, copper, wood, glass, and printed circuit board. The first surface may be selected from: polypropylene, HDPE and LDPE. The first surface may be polypropylene. The first surface may be selected from: HDPE and LDPE.

The second surface may be selected from: polypropylene (PP), poly(ethylene terephthalate) (PET), high density polyethylene (HDPE), low density polyethylene (LDPE), polyvinylchloride (PVC), polystyrene (PS), melamine, cellulose acetate, unspecified polymeric resin, metal (e.g. steel, copper), ceramics, silicon, wood, glass, and printed circuit board. The second surface may be selected from: polypropylene, poly(ethylene terephthalate), HDPE, LDPE, PVC, PS, melamine, cellulose acetate, unspecified polymeric resin, metal, ceramics, silicon and glass. The second surface may be independently selected from: polypropylene (PP), poly(ethylene terephthalate) (PET), high density polyethylene (HDPE), low density polyethylene (LDPE), cellulose acetate, steel, copper, wood, glass, and printed circuit board. The second surface may be selected from: polypropylene, HDPE and LDPE. The second surface may be polypropylene. The second surface may be selected from: HDPE and LDPE.

It may be that at least one of the first and second surfaces forms part of a flexible substrate. It may be that the first surface forms part of a flexible substrate. It may be that the second surface forms part of a flexible substrate. It may be that the first and the second surfaces each form part of a flexible substrate.

The method may be a method of labelling bottles, wherein either the first surface or the second surface is the exterior surface of a bottle and the other of the first surface or the second surface is the label.

It may be that the aqueous emulsion is an aqueous emulsion comprising particles dispersed in an aqueous phase, wherein the particles of the aqueous emulsion comprise a hydrophobic polymer and wherein the particles of the aqueous emulsion are positively charged.

The hydrophobic polymer may be a polystyrene, a polyacrylate, a polymethacrylate, a polyvinyl, a polydiene, or a mixture/copolymer thereof. The hydrophobic polymer may be selected from: polystyrene, poly(butyl acrylate), poly(styrene-butyl acrylate) copolymer or polybutadiene. The hydrophobic polymer may be a polystyrene, a polyacrylate, a polymethacrylate, or a polyvinyl, or a mixture/copolymer thereof. The hydrophobic polymer may be selected from: polystyrene, poly(butyl acrylate), or poly(styrene-butyl acrylate) copolymer. The hydrophobic polymer may be a poly(styrene-butyl acrylate) copolymer.

Where the hydrophobic polymer is a poly(styrene-butyl acrylate) copolymer, the copolymer may comprise styrene and butyl acrylate in a weight ratio in the range of from 3:1 to 0.01:1, e.g. a weight ratio in the range of from 1.5:1 to 1:1.5. It may be that the copolymer comprises styrene and butyl acrylate in a weight ratio of about 1:1.5.

The particles of the aqueous emulsion may further comprise a positively charged polymer (e.g. a polycation). The positively charged polymer (e.g. the polycation) may be associated with the hydrophobic polymer. For example, the positively charged polymer (e.g. the polycation) may be associated with the hydrophobic polymer via hydrophobic, electrostatic, or covalent interactions.

It may be that the components of the particle are arranged and selected such that the positively charged groups (e.g. amino groups) are situated at the surface of the particle. It may be that the components of the particle are arranged and selected such that there is a higher concentration of the positively charged groups (e.g. amino groups) at the surface of the particle than there is in the inner portions of the particle. Thus, the hydrophobic polymer may be situated in the inner portions of the particle with the positively charged polymer situated on the outer portions of the particle.

The positively charged polymer may be a polymeric species comprising one or more positively charged groups. The positively charged polymer may be a polymeric species comprising a plurality of positively charged groups.

In certain embodiments, the aqueous emulsion has a pH of from about 5 to about 8. Preferably, the aqueous emulsion has a pH of about 5. The positively charged polymer (e.g. the polycation) may comprise one or more basic groups that are protonated at the pH of the first aqueous emulsion, e.g. in the pH range from about 5 to about 8, to form a cation. The positively charged polymer (e.g. the polycation) may comprise a plurality of basic groups that are protonated at the pH of the aqueous emulsion, e.g. in the pH range from about 5 to about 8, to form a cation. The positively charged polymer (e.g. the polycation) may comprise one or more amino groups. The positively charged polymer (e.g. the polycation) may comprise a plurality of amino groups. The amino groups may be primary, secondary or tertiary amino groups. The amino groups may be primary amino groups.

The positively charged polymer may be selected from the group comprising: chitosan, poly amino acrylates, poly amino methacrylates, poly allylamines, poly ethyleneimines. The positively charged polymer may be selected from chitosan, poly[2-(dimethylamino)ethyl acrylate], poly[2-(dimethylamino)ethyl methacrylate], and polyethylenimine. The positively charged polymer may be chitosan.

The particles of the aqueous emulsion may be present in an amount in the range from about 20% to about 40% by weight of the aqueous emulsion. The particles of the aqueous emulsion may be present in an amount of about 30% by weight of the aqueous emulsion.

The particles of the aqueous emulsion may comprise the hydrophobic polymer and the positively charged polymer (e.g. the polycation) in a ratio in the range from about 20:1 to about 60:1 by weight of the aqueous emulsion.

The aqueous emulsion may have a low shear viscosity in the range from about 25 to about 100 Pa s. The aqueous emulsion may have a high shear viscosity in the range from about 50 to about 150 mPa s.

The hydrophobic polymer may have a glass transition temperature (T_{g}) of less than about 50 °C, less than about 25 °C, or less than ab out 20 °C. The hydrophobic polymer may have a glass transition temperature (T_{g}) of greater than about −50 °C. The hydrophobic polymer may have a glass transition temperature (T_{g}) of from about −50 °C to about 50 °C, from about −50 °C to about 25 °C, from about −50 °C to about 20 °C, from about −25 °C to about 20 °C, from about 0 °C to about 20 °C, or from about 10 °C to about 20 °C.

The particles of the aqueous emulsion may have a size of in the range about 0.1 to about 200 μm, optionally in the range of from about 80 to about 200 μm. The particles of the aqueous emulsion may have a size of in the range about 10 nm to about 20 μm, optionally in the range of from about 20 nm to about 10 μm.

The particles of the aqueous emulsion may further comprise one or more additives. The one or more additives may each comprise one or more sulfate groups. In embodiments, the particles of the aqueous emulsion comprise a single additive. In embodiments, the particles of the aqueous emulsion comprise a single additive comprising one or more sulfate groups.

Each additive may be a cationic surfactant. For example, the additive may be a cationic surfactant selected from: an alkyl ammonium halide or other alkyl ammonium salt. Specific examples of cationic surfactants include triethylamine hydrochloride, octenidine dihydrochloride, adogen, cetrimonium bromide, cetyl pyridinium chloride, benzethonium chloride and dimethyldioctadecylammonium chloride.

It may be that the aqueous emulsion is an aqueous emulsion comprising particles dispersed in an aqueous phase, wherein the particles of the aqueous emulsion comprise a hydrophobic polymer and wherein the particles of the aqueous emulsion are negatively charged.

The hydrophobic polymer may be a polystyrene, a polyacrylate, a polymethacrylate, a polyvinyl, a polydiene, or a mixture/copolymer thereof. The hydrophobic polymer may be selected from: polystyrene, poly(butyl acrylate), poly(styrene-butyl acrylate) copolymer or polybutadiene. The hydrophobic polymer may be a polystyrene, a polyacrylate, a polymethacrylate, or a polyvinyl, or a mixture/copolymer thereof. The hydrophobic polymer may be selected from: polystyrene, poly(butyl acrylate), or poly(styrene-butyl acrylate) copolymer. The hydrophobic polymer may be a poly(styrene-butyl acrylate) copolymer.

Where the hydrophobic polymer is a poly(styrene-butyl acrylate) copolymer, the copolymer may comprise styrene and butyl acrylate in a weight ratio in the range of from 3:1 to 0.01:1, e.g. a weight ratio in the range of from 1.5:1 to 1:1.5. It may be that the copolymer comprises styrene and butyl acrylate in a weight ratio of about 1:1.5.

The particles of the aqueous emulsion may further comprise a negatively charged polymer (e.g. a polyanion). The negatively charged polymer (e.g. the polyanion) may be associated with the hydrophobic polymer. For example, the negatively charged polymer (e.g. the polyanion) may be associated with the hydrophobic polymer via hydrophobic, electrostatic or covalent interactions.

It may be that the components of the particle are arranged and selected such that the negatively charged groups (e.g. carboxylate groups) are situated at the surface of the particle. It may be that the components of the particle are arranged and selected such that there is a higher concentration of the negatively charged groups (e.g. carboxylate groups) at the surface of the particle than there is in the inner portions of the particle. Thus, the hydrophobic polymer may be situated in the inner portions of the particle with the negatively charged polymer situated on the outer portions of the particle.

The negatively charged polymer may be a polymeric species comprising one or more negatively charged groups. The negatively charged polymer may be a polymeric species comprising a plurality of negatively charged groups.

In certain embodiments, the aqueous emulsion has a pH of from about 5 to about 8, optionally about 5. The negatively charged polymer (e.g. the polyanion) may comprise one or more groups that are deprotonated at the pH of the aqueous emulsion, e.g. in the pH range from about 5 to about 8, to form an anion. The negatively charged polymer (e.g. the polyanion) may comprise a plurality of groups that are deprotonated at the pH of the aqueous emulsion, e.g. in the pH range from about 5 to about 8, to form an anion. The negatively charged polymer (e.g. the polyanion) may comprise carboxylate, sulfonate, phosphonate, or boronate groups. The negatively charged polymer (e.g. the polyanion) may comprise one or more carboxylate groups. The negatively charged polymer (e.g. the polyanion) may comprise a plurality of carboxylate groups.

The negatively charged polymer (e.g. the polyanion) may be selected from the group comprising: poly acrylic acids, acidic biopolymers, poly sulfonic acids and poly maleic acids. The negatively charged polymer (e.g. the polyanion) may be selected from poly(acrylic acid), alginate, carboxymethyl cellulose, xanthan gum, gum Arabic, carrageenan, poly(2-acrylamido-2-methylpropanesulfonic acid), poly(methacrylic acid), poly(maleic acid) and poly(vinyl sulfonic acid). The negatively charged polymer (e.g. the polyanion) is poly(acrylic acid).

The particles of the aqueous emulsion may be present in an amount in the range from about 20% to about 40% by weight of the aqueous emulsion. The particles of the aqueous emulsion may be present in an amount of about 30% by weight of the aqueous emulsion.

The particles of the aqueous emulsion may comprise the hydrophobic polymer and the negatively charged polymer (e.g. the polyanion) in ratio in the range from about 20:1 to about 60:1 by weight of the aqueous emulsion.

The aqueous emulsion may have a low shear viscosity in the range from about 25 to about 100 Pa s. The aqueous emulsion may have a high shear viscosity in the range from about 50 to about 150 mPa s.

The hydrophobic polymer may have a glass transition temperature (T_{g}) of less than about 50 °C, less than about 25 °C, or less than about 20 °C. The hydrophobic polymer may have a glass transition temperature (T_{g}) of greater than ab out −50 °C. The hydrophobic polymer may have a glass transition temperature (T_{g}) of from about −50 °C to about 50 °C, from about −50 °C to about 25 °C, from about −50 °C to about 20 °C, from about −25 °C to about 20 °C, from about 0 °C to about 20 °C, or from about 10 °C to about 20 °C.

The particles of the aqueous emulsion may further comprise one or more additives. The one or more additives may each comprise one or more sulfate groups. In embodiments, the particles of the aqueous emulsion comprise a single additive. In embodiments, the particles of the aqueous emulsion comprise a single additive comprising one or more sulfate groups.

Each additive may be an anionic surfactant. For example, the additive may be an anionic surfactant selected from: an alkyl sulfate, an alkyl ether sulfate, and an alkyl sulfonate. Preferably, the additive is sodium dodecyl sulfate.

The particles of the aqueous emulsion may have a size in the range from about 0.1 to about 200 μm, optionally in the range of from about 80 to about 200 μm.

### BRIEF DESCRIPTION OF THE DRAWINGS

Embodiments of the invention are further described hereinafter with reference to the accompanying drawings, in which:

FIG. 1 shows exemplary first and second emulsions of the adhesive kit of the present invention. The first emulsion (left) comprises a poly(styrene-co-butyl acrylate) core associated with chitosan. The second emulsion (right) comprises a poly(styrene-co-butyl acrylate) core associated with poly(acrylic acid).

FIG. 2 shows the appearance of poly(styrene-butyl acrylate)/chitosan (P(St-BA)/Chi) and poly(styrene-butyl acrylate)/poly(acrylic acid) (P(St-BA)/PAA) emulsions and films.

FIG. 3 shows the proposed detachment mechanism of the first and second emulsions of the adhesive kit of the invention under high and low pH conditions.

FIG. 4 shows a representative image of the reversible adhesion of the kit of the invention at pH 1.

FIG. 5 shows the reversibly adhesive behaviour of P(St-BA)/Chi and P(St-BA)/PAA emulsions, where each sample comprises a first surface of poly(ethylene terephthalate) (PET) and a second surface of polypropylene (PP). Top row pH=1, middle row pH=7, bottom row pH=14. From left to right: sample bonded with P(St-BA)/Chi only; sample bonded with P(St-BA)/PAA only; P(St-BA)/Chi-P(St-BA)/PAA bonded sample with P(St-BA)/Chi coated on PET and P(St-BA)/PAA on PP; and P(St-BA)/PAA-P(St-BA)/Chi bonded sample with P(St-BA)/PAA on PET and P(St-BA)/Chi on PP.

FIG. 6 shows the appearance of poly(styrene-butyl acrylate)/chitosan (P(St-BA)/Chi) and poly(styrene-butyl acrylate)/poly(acrylic acid) (P(St-BA)/PAA) emulsions at the time of production (left) and after 90 days (right).

FIG. 7 shows light-scattering spectra showing the change in particle size distribution of the A) P(St-BA)/Chi emulsion and B) P(St-BA)/PAA emulsion across a 6-month period.

FIG. 8 shows light-scattering spectra showing the change in particle size distribution of the A) P(St-BA)/Chi emulsion and B) P(St-BA)/PAA emulsion across a one-year period.

FIG. 9 shows the force of adhesion of wet P(St-BA)/Chi, P(St-BA)/PAA and P(St-BA)/Chi-P(St-BA)/PAA systems using a PET substrate.

FIG. 10 shows stress vs strain curves for Example 2: A) Representative stress vs strain curves for PP. B) Representative stress vs strain curves for PET.

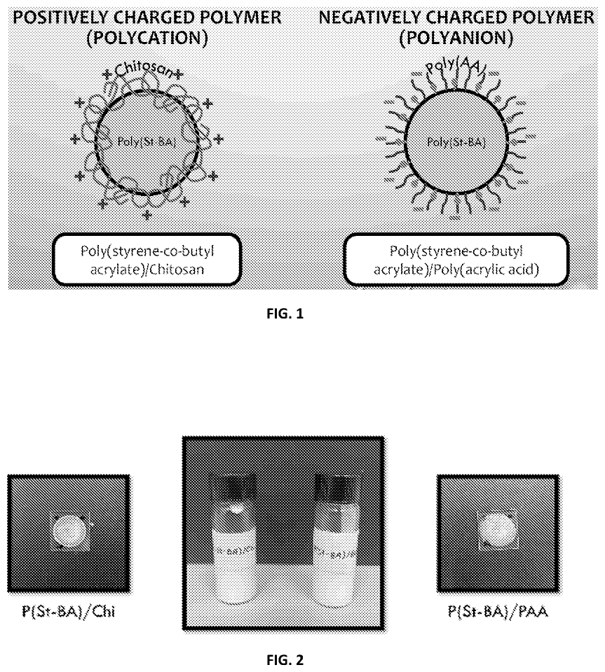

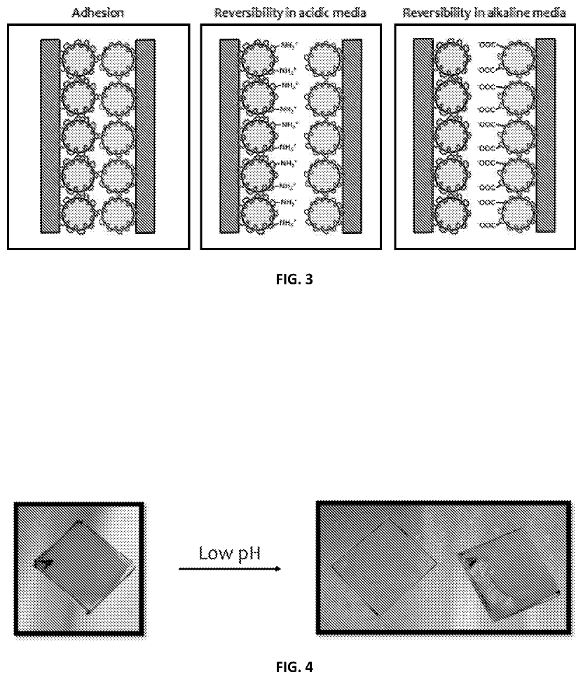

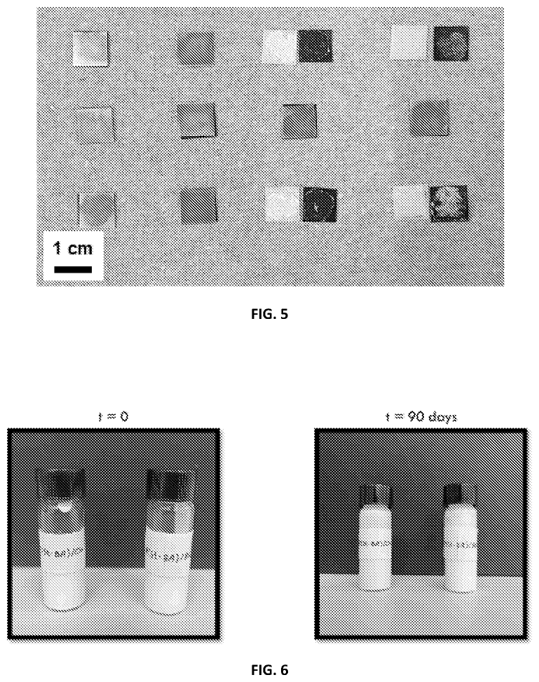

### DETAILED DESCRIPTION

The term “polymer” used herein may refer to a single species of polymer or to a polymeric mixture comprising multiple species of polymer blended or bonded together to create a new material with different physical properties to each individual species of polymer.

The term “hydrophobic” used herein refers to a species that repels or is immiscible with water.

The term “emulsion” used herein may refer to a dispersion of particles in a liquid phase, the particles and liquid phase being immiscible with one another. The particles comprise polymer, e.g. the first hydrophobic polymer or the second hydrophobic polymer. The particles may be solid particles, semi-solid particles, or liquid particles. The liquid phase is typically an aqueous phase. Thus, the particles are typically hydrophobic.

The term “glass transition” used herein refers to the gradual and reversible transition in amorphous materials from a hard and relatively brittle state into a viscous or rubbery state as temperature is increased.

The term “glass transition temperature” or “T_{g}” used herein refers to the temperature or range of temperatures at which the glass transition occurs. The glass transition temperature is lower than the melting temperature of the crystalline state of the material.

The terms “positively charged” and “negatively charged” as used herein refer to the charge state of the particles of the first and second aqueous emulsions at the pH of the respective emulsion, i.e. the pH of the respective aqueous phase. The terms may mean that the particles are positively or negatively charged at a pH in the range of about 5 to about 8, e.g. about 7.

The term “organic solvent” may refer to a solvent system selected from: hydrocarbons (e.g. petrol ether, hexane, heptane) ethers (e.g. dimethylethylene glycol, diethyl ether, t-butylmethyl ether, tetrahydrofuran, dioxane), esters (e.g. ethyl acetate), ketones (e.g. acetone, t-butylmethylketone), amides (e.g. N-methylpyrrolidine, dimethylformamide, dimethylacetamide), sulfoxides (e.g. dimethylsulfoxide), aromatic solvents (e.g. benzene, toluene), chlorinated solvents (e.g. chloroform, dichloromethane, 1,2-dichloroethane), turpentine, or mixtures thereof.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

### EXAMPLES

### Materials and Methods

Sodium dodecyl sulfate (SDS) (NaCl₂H₂₅SO₄, ≥98.5%), chitosan (Chi) (medium molecular weight), acetic acid (AAc) (CH₃COOH, 99.8-100.5%), styrene (St) (C₈H₈, ≥99%), acrylated epoxidized soybean oil (AESO), butyl acrylate (BA) (C₇H₁₂₀₂, stabilized for synthesis), acrylic acid (AA) (CH₂CHCOOH, 99%), and potassium persulfate (KPS) (K2S208, ≥99.0%) were all purchased from Sigma-Aldrich were used as received for the synthesis of the emulsions. Hydrochloric acid (HCl) (37%), sodium hydroxide (NaOH) (≥98), ethanol (absolute for analysis), and acetone (≥99.5%) purchased from Sigma-Aldrich were used as received for reversibility, swelling, and film stability tests. Distilled turpentine purchased from Winsor & Newton art supplies was used for film stability tests.

Mylar® plastic films (PET) 0.25 mm thickness and polypropylene (PP) plastic films 0.127 mm thickness were purchased from RS Components and used for the reversibility experiments. Mylar® plastic films (PET) 0.25 mm thickness and polypropylene plastic films 0.45 mm thickness were purchased from RS Components and used for the lap shear strength measurements. Cyanoacrylate Superglue purchased from RS Components and hanging hooks from JELLYSUB were used for the tensile strength demonstrations.

### Example 1

### Synthesis of Emulsion 1: poly(styrene-butyl acrylate)/chitosan (P(St-BA)/Chi)

The synthesis of P(St-BA)/Chi was performed via free-radical emulsion polymerisation. It was carried out in a 100 mL three-neck flask in an oil bath where 20 mL of a 1.0 wt % acetic acid solution in deionised water was poured and 0.3 g of Chi added and dissolved overnight (~15 h). Then, the stirring speed was increased as 4.5 mL of BA and 3.5 mL of St were added dropwise over 10 min and the nitrogen flow was turned on. The emulsion was left to develop for 10 min before h eating to 70 °C. When the temperature reached 60 °C, 40 mg of KPS in 1.2 mL of deionised water was added dropwise and stirring was lowered. The nitrogen flow was lowered as the temperature reached 70 °C and the reaction was left to proceed for 4 h. The resulting emulsion was collected in a vial and stored.

### Synthesis of Emulsion 2: poly(styrene-butyl acrylate)/poly(acrylic acid) (P(St-BA)/PAA)

The synthesis of P(St-BA)/PAA was performed via free-radical emulsion polymerisation. It was carried out in a 100 mL three-neck flask in an oil bath where 20 mL of deionised water was poured, and 0.3 g of sodium dodecyl sulfate (SDS) added and dissolved for 5 min under stirring. Then, 5 mL of BA and 4 mL of St were added dropwise over 5 min and the nitrogen flow was turned on. The emulsion was left to develop for 10 min before heating to 70 °C. When the temperature reached 60 °C, 1.2 mL of a KPS solution (50 mg of KPS in 1.5 ml of water) was added dropwise. The nitrogen flow was lowered as the temperature reached 70 °C and the reaction was left to proceed for 2 h. After that time, the remaining 0.3 mL of KPS solution was added followed by an acrylic acid solution (0.750 ml of AA in 1.5 mL of water), both dropwise. Polymerisation proceeded for further 2 h and the resulting emulsion was collected in a vial and stored.

### Results

Both P(St-BA)/Chi and P(St-BA)/PAA emulsions are white in colour and exhibit a paint-like texture. They are easily spreadable with a brush on plastic substrates, particularly PET films can be formed by leaving the emulsion to dry on a flat plastic substrate. While P(St-BA)/PAA remains white in colour, P(St-BA)/Chi acquires a yellow shade due to the presence of chitosan. Exemplary emulsions and films are shown in FIG. 2.

The reversibility of the two-phase adhesive was evaluated at pH=1 and at pH=14. Samples were prepared by coating polyethylene terephthalate (PET) and polypropylene (PP) films with each of the emulsions, which were then brought in contact and left to dry at room temperature. Two sets of each from three different batches were prepared and then immersed in either deionised water, an HCl solution pH=1, or a NaOH solution pH=14 at room temperature. The following table identifies each sample.

TABLE 1
Samples and testing conditions.

| Emulsion on PET | Emulsion on PP | Medium |
|---|---|---|
| P(St-BA)/Chi | P(St-BA)/PAA | Water |
| P(St-BA)/PAA | P(St-BA)/Chi | Water |
| P(St-BA)/Chi | P(St-BA)/PAA | HCl solution |
| P(St-BA)/PAA | P(St-BA)/Chi | HCl solution |
| P(St-BA)/Chi | P(St-BA)/PAA | NaOH solution |
| P(St-BA)/PAA | P(St-BA)/Chi | NaOH solution |

Adhesion was evaluated periodically. After one night, adhesion had failed in the samples exposed to the acidic or alkaline solution (FIGS. 4 and 5). Adhesion remained in the samples immersed in water.

The stability at room temperature (shelf life) is evaluated by storing each emulsion in a glass vial, tightly sealed at constant conditions. The average storage temperature is 20 °C and the vials are kept away from sunlight. Stability was evaluated based on their appearance. Particularly, the formation of precipitates would indicate emulsion destabilisation. While P(St-BA)/Chi displayed a phase separation after 25 days, this can be reversed by shaking with no effects on the emulsion behaviour. Emulsions remained stable for 90 days at the conditions described.

Further stability tests were conducted having stored the emulsions at a temperature of between 16 °C to 20 °C over a period of 6 months and 12 months. Stability was monitored by measuring the particle size by means of light scattering analysis using a Zetasizer Nano. One droplet of the as-prepared emulsion was diluted with 2 ml of water in a polystyrene cuvette. Each measurement was repeated three times, and the mean particle size and polydispersity index (PDI) reported. The test was repeated each month for 12 months.

TABLE 2
Stability over 6 months and 12 months

| | As prepared | | After 6 months | | After 12 months | |
|---|---|---|---|---|---|---|
| | Mean size | | Mean size | | Mean size | |
| Formulation | (d, nm) | PDI | (d, nm) | PDI | (d, nm) | PDI |
| P(St-BA)/Chi | 306.0 ± 8.4 | 0.096 | 350.8 ± 22.9 | 0.096 | 459.0 ± 29.7 | 0.104 |
| P(St-BA)/PAA | 122.2 ± 10.9 | 0.249 | 139.3 ± 10.2 | 0.259 | 178.2 ± 24.1 | 0.282 |

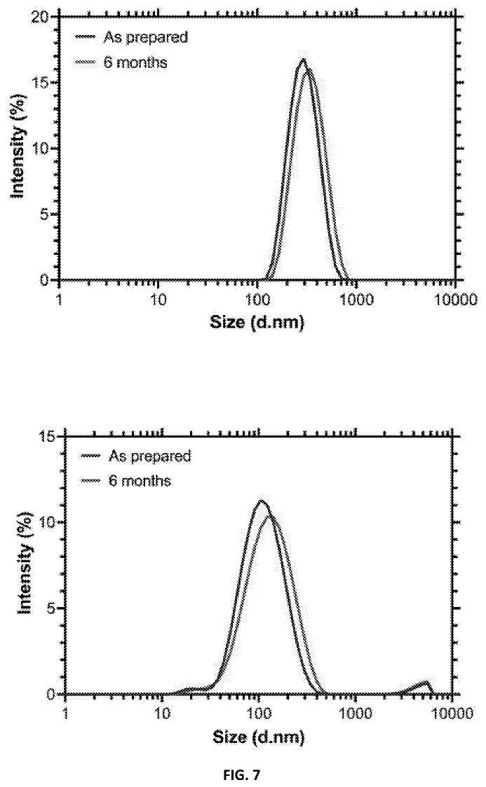

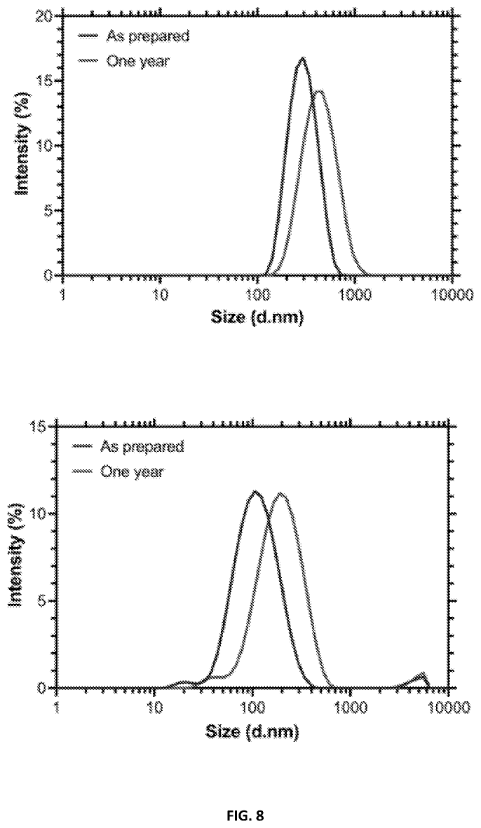

As depicted in Table 2 above, after 6 months of storage, the mean particle size of P(St-BA)/Chi increased from 306.0 nm to 350.8 nm. Across the same time period, the mean particle size of P(St-BA)/PAA increased from 122.2 nm to 139.3 nm. After 12 months of storage, the mean particle size of P(St-BA)/Chi increased from 306.0 nm to 459.0 nm, and the mean particle size of P(St-BA)/PAA increased from 122.2 nm to 178.2 nm. These results are further depicted in the light scattering spectra of FIGS. 7 and 8.

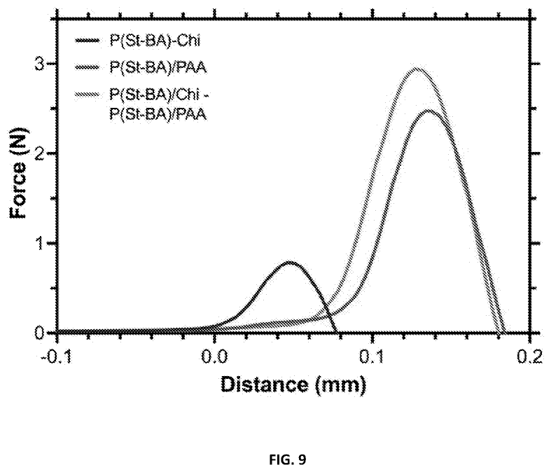

The force of adhesion of the emulsions in the wet state was measured using a Stable Microsystems TA.XTplusC Texture Analyser. The instrument consists of a cylindrical probe that approaches a surface and measures the force required for the probe to detach. A PET film was attached to the bottom part of the probe and to the surface. For every test, each was covered with either the P(St-BA)/Chi or P(St-BA)/PAA emulsions. A control test was first recorded for water to discard possible cohesion effects. Forces of adhesion between P(St-BA)/Chi or P(St-BA)/PAA emulsions and themselves were recorded. Then, the surface PET was coated with the cationic emulsion, the probe PET with anionic emulsion, and the force of adhesion measured. The probe speed was set at 50 mm min-1, it was held on the surface with a force of 0.5 N for 1 min and then receded at the same speed. The results are depicted in FIG. 9.

### Example 2

The lap shear strengths of the individual adhesive formulations of Example 1 and the system were measured using polypropylene (PP) and poly(ethylene terephthalate) (PET) as substrates. In a typical test, two plastic films were carefully cleaned using acetone and glued by an overlapping area of 0.5 in² (~3.2 cm²). The adhesive was applied to both films, they were joined with a force of 1 N and the excess adhesive was cleaned away. After the adhesive dried, tensile tests were performed on each sample.

The amounts of adhesive applied to the films was:
175 mg of P(St-BA)/Chi on PET
60 mg of P(St-BA)/Chi on PP
25 mg of P(St-BA)/PAA on PET
30 mg of P(St-BA)/PAA on PP

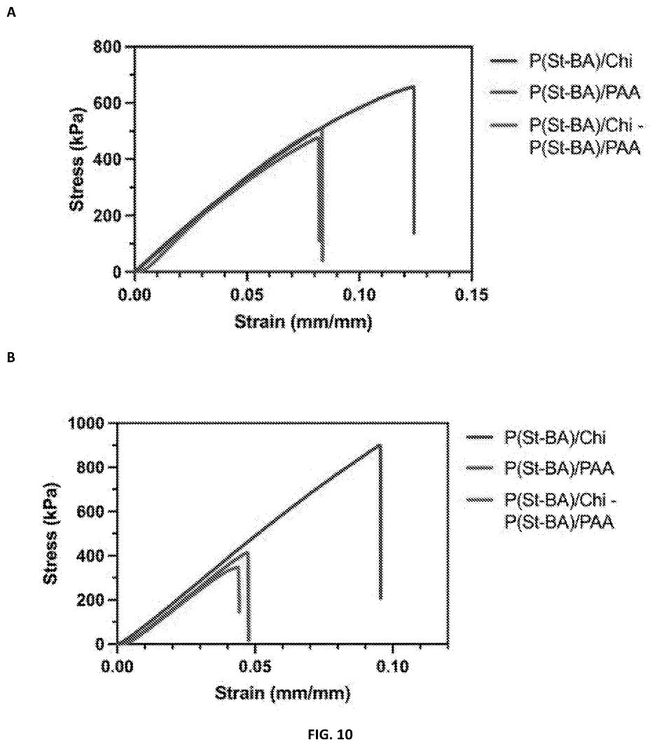

The measured lap shear strengths are presented in Table 2 and the corresponding stress vs strain curves in FIG. 10.

TABLE 2
Lap shear strength values.

| | Lap shear | Lap shear |
|---|---|---|
| Adhesive | strengths for PP | strengths for PET |
| P(St-BA)/Chi | 0.64 MPa ± 0.02 MPa | 0.91 MPa ± 0.08 MPa |
| P(St-BA)/PAA | 0.49 MPa ± 0.04 MPa | 0.40 MPa ± 0.02 MPa |
| P(St-BA)/Chi - P(St- | 0.49 MPa ± 0.06 MPa | 0.36 MPa ± 0.03 MPa |
| BA)/PAA (Method | | |
| according | | |
| to Example 1) | | |

Further strength testing was performed on two low density polyethylene (LDPE) films glued by P(St-BA)/Chi over an overlapping area of 0.5 in² (~3.2 cm²) and holding a weight of 300 g, compared to a commercial cyanoacrylate glue holding same weight. While both glues were found to support the weight, only the samples glued with P(St-BA)/Chi remained flexible, while the commercial glue resulted in a rigid, brittle joint. This benefit is observed with all adhesive formulations of the invention.

A reversibility test was performed for pairs of PP and PET samples adhered to each other using individual formulations and the complementary adhesive system. Samples were exposed to water, pH 1 HCl solution and pH 14 NaOH solution. It was found that samples bonded with either only P(St-BA)/Chi or only P(St-BA)/PAA formulations did not detach in any of the conditions, hence verifying the adhesive strength for different substrates. Detachment from the substrates was achieved by using solvents such as acetone and turpentine.

Adhesion was also achieved with the formulations of Example 1 and Example 2 using a substrate of polyethylene, cellulose acetate, glass, wood, steel, copper, and printed circuit boards surface.

1. An adhesive kit comprising
a first aqueous emulsion comprising particles dispersed in a first aqueous phase, wherein the particles of the first aqueous emulsion comprise a first hydrophobic polymer and wherein the particles of the first aqueous emulsion are positively charged, and
a second aqueous emulsion comprising particles dispersed in a second aqueous phase, wherein the particles of the second aqueous emulsion comprise a second hydrophobic polymer and wherein the particles of the second aqueous emulsion are negatively charged,
wherein the first and second aqueous emulsions are configured to reversibly adhere to one another.

2. The adhesive kit of claim 1, wherein the particles of the first aqueous emulsion further comprise a positively charged polymer.

3. The adhesive kit of claim 2, wherein the positively charged polymer comprises one or more basic groups that are protonated at the pH of the first aqueous emulsion to form a cation.

4. The adhesive kit of claim 2 or claim 3, wherein the positively charged polymer comprises one or more amino groups.

5. The adhesive kit of any of claims 2 to 4, wherein the positively charged polymer is selected from: chitosan, poly[2-(dimethylamino)ethyl acrylate], poly[2-(dimethylamino)ethyl methacrylate], and polyethylenimine.

6. The adhesive kit of any preceding claim, wherein the particles of the second aqueous emulsion further comprise a negatively charged polymer.

7. The adhesive kit of claim 6, wherein the negatively charged polymer comprises one or more groups that are deprotonated at the pH of the second aqueous emulsion to form an anion.

8. The adhesive kit of claim 6 or claim 7, wherein the negatively charged polymer comprises one or more carboxylate, sulfonate, phosphonate or boronate groups.

9. The adhesive kit of any of claims 6 to 8, wherein the negatively charged polymer is selected from: poly(acrylic acid), alginate, carboxymethyl cellulose, xanthan gum, gum Arabic, carrageenan, poly(2-acrylamido-2-methylpropanesulfonic acid), poly(methacrylic acid), poly(maleic acid) and poly(vinyl sulfonic acid)

10. The adhesive kit of any preceding claim, wherein the particles of the second aqueous emulsion further comprise an additive comprising one or more sulfate groups.

11. The adhesive kit of claim 10, wherein the additive is sodium dodecyl sulfate.

12. The adhesive kit of any preceding claim, wherein the particles of the first aqueous emulsion are present in an amount of about 30% by weight of the first aqueous emulsion.

13. The adhesive kit of any preceding claim, wherein the particles of the second aqueous emulsion are present in an amount of about 30% by weight of the second aqueous emulsion.

14. The adhesive kit of any preceding claim, wherein both the first hydrophobic polymer and second hydrophobic polymer are poly(styrene-butyl acrylate) copolymer.

15. The adhesive kit of any preceding claim, wherein the first and second aqueous emulsions have a pH in the range of about 5 to about 8.

16. The adhesive kit of any preceding claim, wherein the particles of the first aqueous emulsion and the particles of the second aqueous emulsion have a size of from about 20 nm to about 10 μm.

17. A method of using the adhesive kit of any of claims 1 to 16 to adhere two surfaces to one another, comprising:
coating a first surface with the first aqueous emulsion;
coating a second surface with the second aqueous emulsion; and
contacting the first surface coated with the first aqueous emulsion with the second surface coated with the second aqueous emulsion to adhere the first and second surfaces to one another at a bonded interface.

18. The method of claim 17, further comprising reducing the pH of the first and second surfaces at the bonded interface to detach the first and second surfaces from one another.

19. The method of claim 17 or 18, wherein the method is a method of labelling bottles, wherein either the first surface or the second surface is the exterior surface of a bottle and the other of the first surface or the second surface is the label.

20. A method of producing the adhesive kit of any of claims 1 to 16, the method comprising forming the first aqueous emulsion and second aqueous emulsion.

21. A method of adhering two surfaces to one another, the method comprising: coating a first surface and/or a second surface with an aqueous emulsion; and contacting the first surface with the second surface to adhere the first and second surfaces to one another at a bonded interface; wherein the aqueous emulsion is selected from:
an aqueous emulsion comprising particles dispersed in an aqueous phase, wherein the particles of the aqueous emulsion comprise a hydrophobic polymer and wherein the particles of the aqueous emulsion are positively charged; and
an aqueous emulsion comprising particles dispersed in an aqueous phase, wherein the particles of the aqueous emulsion comprise a hydrophobic polymer and wherein the particles of the aqueous emulsion are negatively charged.

22. A method of claim 21, wherein the aqueous emulsion is an aqueous emulsion comprising particles dispersed in an aqueous phase, wherein the particles of the aqueous emulsion comprise a hydrophobic polymer and wherein the particles of the aqueous emulsion are positively charged.

23. The method of claim 22, wherein the particles of the aqueous emulsion further comprise a positively charged polymer.

24. The method of claim 23, wherein the positively charged polymer comprises one or more basic groups that are protonated at the pH of the aqueous emulsion to form a cation.

25. The method of claim 23 or 24, wherein the positively charged polymer comprises one or more amino groups.

26. The method of any of claims 23 to 25, wherein the positively charged polymer is selected from: chitosan, poly[2-(dimethylamino)ethyl acrylate], poly[2-(dimethylamino)ethyl methacrylate], and polyethylenimine.

27. A method of claim 21, wherein the aqueous emulsion is an aqueous emulsion comprising particles dispersed in an aqueous phase, wherein the particles of the aqueous emulsion comprise a hydrophobic polymer and wherein the particles of the aqueous emulsion are negatively charged.

28. The method of claim 27, wherein the particles of the aqueous emulsion further comprise a negatively charged polymer.

29. The method of claim 28, wherein the negatively charged polymer comprises one or more groups that are deprotonated at the pH of the aqueous emulsion to form an anion.

30. The method of claim 28 or claim 29, wherein the negatively charged polymer comprises one or more carboxylate, sulfonate, phosphonate or boronate groups.

31. The method of any of claims 28 to 30, wherein the negatively charged polymer is selected from: poly(acrylic acid), alginate, carboxymethyl cellulose, xanthan gum, gum Arabic, carrageenan, poly(2-acrylamido-2-methylpropanesulfonic acid), poly(methacrylic acid), poly(maleic acid) and poly(vinyl sulfonic acid)

32. The method of any one of claims 27 to 31, wherein the particles of the aqueous emulsion further comprise an additive comprising one or more sulfate groups.

33. The method of claim 32, wherein the additive is sodium dodecyl sulfate.

34. The method of any one of claims 21 to 33, wherein the particles of the aqueous emulsion are present in an amount of about 30% by weight of the aqueous emulsion.

35. The method of any one of claims 21 to 34, wherein the hydrophobic polymer is poly(styrene-butyl acrylate) copolymer.

36. The method of any one of claims 21 to 35, wherein the aqueous emulsion has a pH in the range of about 5 to about 8.

37. The method of any one of claims 21 to 36, wherein the particles of the aqueous emulsion have a size of from about 20 nm to about 10 μm.

38. The method of any one of claims 21 to 37, wherein the first surface is selected from: polypropylene, HDPE, and LDPE.

39. The method of claim 38, wherein the second surface is selected from: polypropylene, HDPE, and LDPE.

40. The method of any one of claims 21 to 37, wherein at least one of the first surface and the second surface are polypropylene.

41. The method of any one of claims 21 to 37, wherein both the first surface and the second surface are polypropylene.
